(19) United States
(12) Patent Application Publication
(10) Pub. No.: US 2003/0118431 A1
(43) Pub. Date: Jun. 26, 2003

(54) Fork lift apparatus and methods of lifting and positioning a load

(76) Inventor: Lou Marrero, Orlando, FL (US)

Correspondence Address: Jeffrey S. Whittle, Esq., ALLEN, DYER, DOPPELT, MILBRATH & GILCHRIST, 255 South Orange Avenue - Suite 1401, P.O. Box 3791, Orlando, FL, 32802-3791, US

(21) Appl. No.: 10/027,921

(22) Filed: Dec. 20, 2001

(51) Int. Cl. B66F 9/06

(52) U.S. Cl. 414/667

(57) ABSTRACT

A fork lift apparatus having multiple degrees of freedom of movement and methods of positioning a load are provided. More particularly, the fork lift apparatus preferably includes a base, a fork lift frame slidably connected thereto between a retracted and an extended position and a fork lift connected to the fork lift frame and positioned to slidably move between a lowered and an elevated position. The fork lift apparatus also preferably includes an operator station connected to the fork lift to slidably extend between a retracted and an extended position to counterbalance a load positioned on the fork lift apparatus. The fork lift apparatus further preferably includes a controller to control the fork lift apparatus and a drive assembly to drive the fork lift apparatus.

### FIELD OF THE INVENTION

The present invention relates to the cargo transport industry and more particularly, the field of transporting cargo within a narrow aisle and associated methods.

### BACKGROUND OF THE INVENTION

Fork lifts have been generally known for many years and have been widely used in such areas as warehouses and cargo receiving areas to move loads, e.g., loads placed on pallets. One way that large warehouses can better utilize their space is to increase the number of aisles of products within the warehouse. This has led to the use of narrower aisles within the warehouse. Therefore, a problem that arose with the use of traditional fork lifts, i.e., front-loading fork lifts, is that they can no longer effectively be used in warehouses having narrow aisles or cargo receiving areas having narrow areas that are only suitable for a small turning radius. It is quite difficult to maneuver traditional front-loading fork lifts having an elongate load positioned thereon in a balanced manner so that a longitudinal axis of the elongate load is parallel with the longitudinal axis of a typical narrow aisle. Therefore, these elongate loads are normally moved using manual labor which can be costly and time consuming or using some other form of machinery that can only be dedicated to the movement of these elongate loads, such as overhead crane or pulley and hoist systems. These systems can prove to be costly, difficult to install, and require extensive training for operation.

Side loading fork lifts have previously been used to maneuver loads within narrow areas. For example, U.S. Pat. No. 3,757,899 titled “Double Mast Side Loader Lift Truck and Double Actuator Balancing” by Smith, Jr., describes a side loader lift truck that moves in forward and rearward directions. The side loader lift truck described in Smith Jr. '899 also includes forks that laterally extend from the lift truck. These types of devices, however, are disadvantageous when trying to conserve time and manual labor cost because they are only adapted to move in either forward or rearward directions. They can also disadvantageously limit maneuverability capabilities of the side loader lift truck which can be important when moving loads in a narrow area. The operator's platform described in Smith Jr. '899 is adjustable along with the load. This can be disadvantageous because of the danger presented to the operator, i.e., being moved vertically up and down with a heavy or elongate load.

Another type of loading apparatus is illustrated and described in U.S. Pat. No. 2,773,612 titled “Apparatus For Loading and Unloading Trailers and The Like Onto and From Platforms and The Like” by West et al. This type of loading apparatus loads and unloads trailers, i.e., tractor trailers that are transported by large trucks from railroad cars. The lifting forks on these types of loading apparatuses are positioned to surround the tires of the trailer to be lifted. The lifting apparatus also includes a set of driven wheels that operate similar to the wheels of a vehicle, i.e., forward and rearward travel. The lifting apparatus also includes a pair of the wheels adapted to pivot to thereby steer the vehicle. This type of lifting apparatus can include another set of support wheels that are positioned to support a load, e.g., the trailer, when being loaded onto or unloaded off of the railroad car. This configuration is disadvantageous because in order for the operator to maneuver the vehicle in any other direction except for forward and rearward, a plurality of “turns” must be performed. For example, in order for the lifting apparatus to be moved closer to or further from the railroad car, a series of turns, i.e., three-point turns, must be performed. This disadvantageously requires a high level of training, precision, and extended periods of time on the part of the operator. A risk that is presented by this type of apparatus, is that the operator is positioned at a lower fixed elevation. This can prove to be dangerous as it may be difficult for the operator to visualize an area positioned directly in front of the load. For example, an obstacle or a person can be easily hit or injured if positioned in front of the lifting apparatus and not visualized by the operator.

### SUMMARY OF THE INVENTION

With the foregoing in mind, the present invention advantageously provides a fork lift apparatus and associated methods that is advantageously adapted to easily move in forward, rearward, lateral, and transverse directions to solve the problem of limited maneuverability of a cargo handling device in a predetermined area. The present invention also advantageously identifies the source of the problems associated with increased time and labor necessary to move loads and provides the elegant solution of a highly maneuverable and easily operable fork lift apparatus. The present invention further advantageously solves the problem of hazards that are encountered when an operator does not have a clear and unobstructed view of an area surrounding the fork lift apparatus. The present invention still further recognizes the problem associated with an operator having a view obstructed by a load positioned on the fork lift apparatus during operation and advantageously provides the unique solution of an operator station that is elevated above a load so that an operator positioned therein will have an unobstructed view of an area surrounding the fork lift apparatus.

The present invention also advantageously recognizes the problem of stabilizing a load positioned on a fork lift apparatus so as to prevent the load from falling off of the fork lift apparatus. The present invention further advantageously recognizes the problem of transporting loads in an unbalanced manner and provides the elegant solution of providing counter weights so as to advantageously counter balance the weight of a load positioned on the fork lift apparatus. The present invention still further advantageously recognizes and solves the problem of detecting unbalanced weight distribution on the fork lift apparatus by providing an operator station having a weight balance meter so that the operator station is positioned to slidably move between a retracted position and an extended position to counterbalance the load positioned on the fork lift apparatus.

More particularly, the fork lift apparatus of the present invention preferably includes a base having a front, a rear, and first and second sides extending between the front and the rear, the base having a first pair of spaced-apart fork lift frame guide rails, connected to the respective first and second sides of the base. The fork lift apparatus of the present invention also preferably includes a fork lift frame having a pair of spaced-apart and opposing side frame members each positioned to slidably connect to one of the first pair of fork lift frame guide rails. The fork lift frame is advantageously adapted to slidably move between a retracted position and an extended position and further preferably includes a second pair of fork lift frame guide rails, each positioned to extend upwardly along the respective pair of spaced-apart and opposing side frame members. The fork lift apparatus of the present invention further preferably includes a fork lift slidably connected to and extending between the second pair of fork lift frame guide rails so that the fork lift moves between a lowered position and an elevated position along the pair of spaced-apart and opposing side frame members. The fork lift apparatus of the present invention still further preferably includes a controller connected to the base, the fork lift frame and the fork lift positioned to control the movement of the fork lift frame between the extended and retracted positions and the movement of the fork lift between the elevated and lowered positions. The fork lift apparatus also preferably includes a drive assembly connected to the base, the fork lift frame, the fork lift, and the controller to drive the fork lift frame between the extended and retracted positions, and the fork lift between the elevated and lowered positions, each driven independently of one another and responsive to the controller.

The present invention also preferably includes a method of moving a predetermined load using a fork lift apparatus having a base. The method preferably includes extending a fork lift frame from a retracted position to engage a load, elevating a fork lift connected to the fork lift frame to lift the load, and retracting the fork lift frame to a retracted position so that the lifted load of the elevated fork lift is positioned to overlie the base. The present invention further advantageously includes a method of positioning a load within a predetermined area using a fork lift apparatus having a base with a longitudinal axis. The method preferably includes longitudinally moving the fork lift apparatus in a first predetermined direction along a longitudinal axis of the predetermined area so that the longitudinal axis of the base is positioned substantially parallel to the longitudinal axis of the predetermined area. The method also preferably includes extending a fork lift frame so that a fork lift connected thereto is positioned to engage and lift the load. The method further preferably includes laterally moving the fork lift apparatus in a second predetermined direction so that the longitudinal axis of the base is positioned substantially perpendicular to the longitudinal axis of the predetermined area.

The fork lift apparatus and associated methods of the present invention advantageously allow a fork lift apparatus having a load positioned thereon to be maneuvered in a plurality of directions, i.e., forward, rearward, lateral, and transverse in a balanced manner so as to prevent the hazards associated with an unbalanced load positioned on the fork lift apparatus. This advantageously allows a load to be readily positioned within the confines of a predetermined area in a time efficient and cost effective manner. The fork lift apparatus of the present invention also advantageously provides many degrees of freedom of movement to allow for increased maneuverability. The retraction and extension capabilities of the fork lift frame advantageously provide substantially balanced movement of the fork lift apparatus when a load is positioned thereon. The elevation and lowering capabilities of the fork lift advantageously allow the load to be positioned between the elevated and lowered positions while the fork lift frame is moved between the retracted and extended positions. Further, the load positioned on the fork lift apparatus can advantageously be positioned between the elevated and lowered positions, and the retracted and extended positions while the base is positioned to maneuver in the predetermined area in a smooth and continuous motion without any need to stop between each of the different degrees of movement.

### BRIEF DESCRIPTION OF THE DRAWINGS

Some of the features, advantages, and benefits of the present invention having been stated, others will become apparent as the description proceeds when taken in conjunction with the accompanying drawings in which:

FIG. 1 is a perspective view of a fork lift apparatus according to the present invention;

FIG. 2 is a fragmentary perspective view of an operator station being positioned between an extended position and a retracted position according to the present invention;

FIG. 3 is a fragmentary perspective view of a fork lift apparatus having portions of the operator station broken away to show the interior of the operator station according to the present invention.

FIG. 4 is a side elevation view of a fork lift apparatus showing a fork lift frame and an operator station being positioned between extended and retracted positions according to the present invention;

FIG. 5A is a side elevation view of a fork lift apparatus being positioned to engage a load according to the present invention;

FIG. 5B is a side elevation view of a fork lift apparatus being positioned to lift a load and position it over the base of the fork lift apparatus according to the present invention;

FIG. 6 is an environmental top plan view of a warehouse having aisles and a fork lift apparatus being maneuvered in multiple directions according to the present invention;

FIG. 7 is a front perspective view of a fork lift apparatus having portions of the base broken away to show a drive assembly according to the present invention;

FIG. 8 is a fragmentary perspective view of a fork guide and a prong guide positioned to engage a fork guide connector and a prong guide connector according to the present invention;

FIG. 9 is a sectional view of the fork guide taken along line 9-9 in FIG. 8 according to the present invention;

FIG. 10 is a fragmentary sectional view of the fork guide connector taken along line 10-10 in FIG. 8 according to the present invention;

FIG. 11 is a fragmentary sectional view of the prong guide taken along line 11-11 in FIG. 8 according to the present invention;

FIG. 12 is a fragmentary sectional view of the prong guide connected taken along line 12-12 in FIG. 8 according to the present invention;

FIG. 13 is fragmentary perspective view of an operator station having a counterweight extending outwardly from the rear according to the present invention;

FIG. 14 is a fragmentary side elevation view of an operator station having a counterweight connected thereto, the operator station and the counterweight being positioned between extended and retracted positions according to the present invention; and

FIG. 15 is a fragmentary perspective view of an instrumentation panel in an operator station showing the communication between a plurality of strain gauges positioned on the fork lift apparatus and a plurality of strain gauge instruments positioned in the operator station according to the present invention.

### DETAILED DESCRIPTION OF THE PREFERRED EMBODIMENTS

The present invention will now be described more fully hereinafter with reference to the accompanying drawings which illustrate preferred embodiments of the invention. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, the prime notation, if used, indicates similar elements in alternative embodiments.

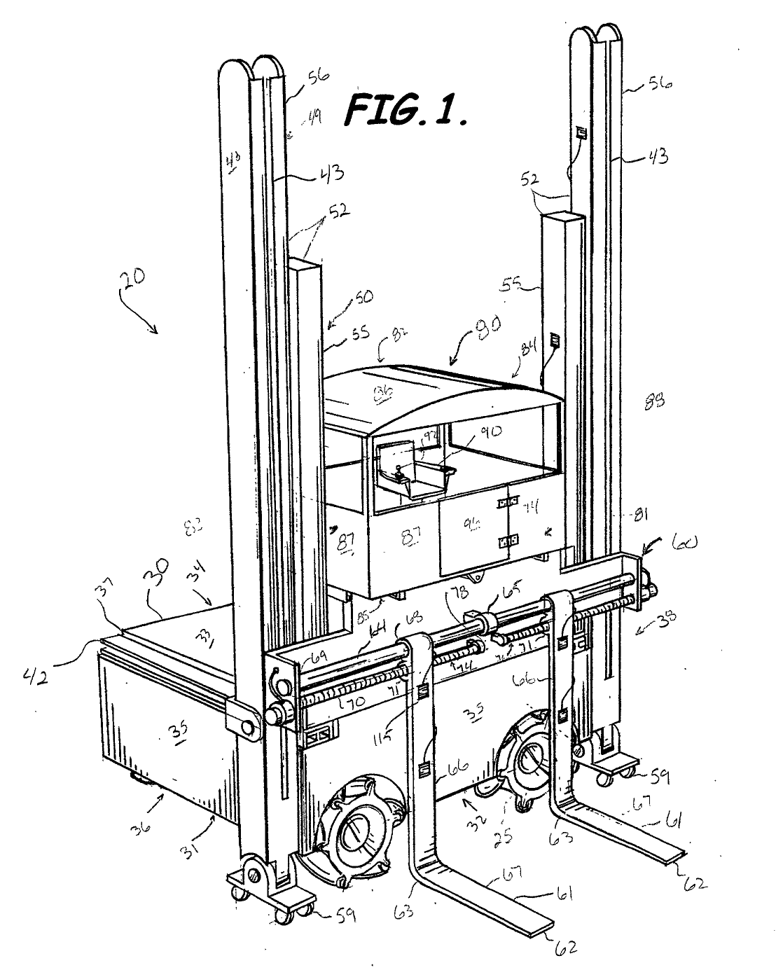

As illustrated in FIGS. 1-15, the present invention advantageously provides a fork lift apparatus 20 and associated methods to move a predetermined load L in a predetermined area A. More particularly, as perhaps best illustrated in FIG. 1, the fork lift apparatus 20 of the present invention advantageously includes a base 30. The base 30 preferably includes a front 32, a rear 34, and first and second sides 36, 38 extending between the front and the rear. The base 30 also preferably includes a bottom 31 and a top 33 and a plurality of sidewalls 35 extending between the bottom 31 and the top 33. The first side 36 is preferably positioned substantially opposite the second side 38. The top 33, bottom 31, and plurality of sidewalls 35 are preferably made of a lightweight composite material, but can also be made of metal, plastic, or any other type of material that is light in weight and includes high strength properties as understood by those skilled in the art. The base 30 is preferably rectangular, but can also be square or have rounded edges, as understood by those skilled in the art.

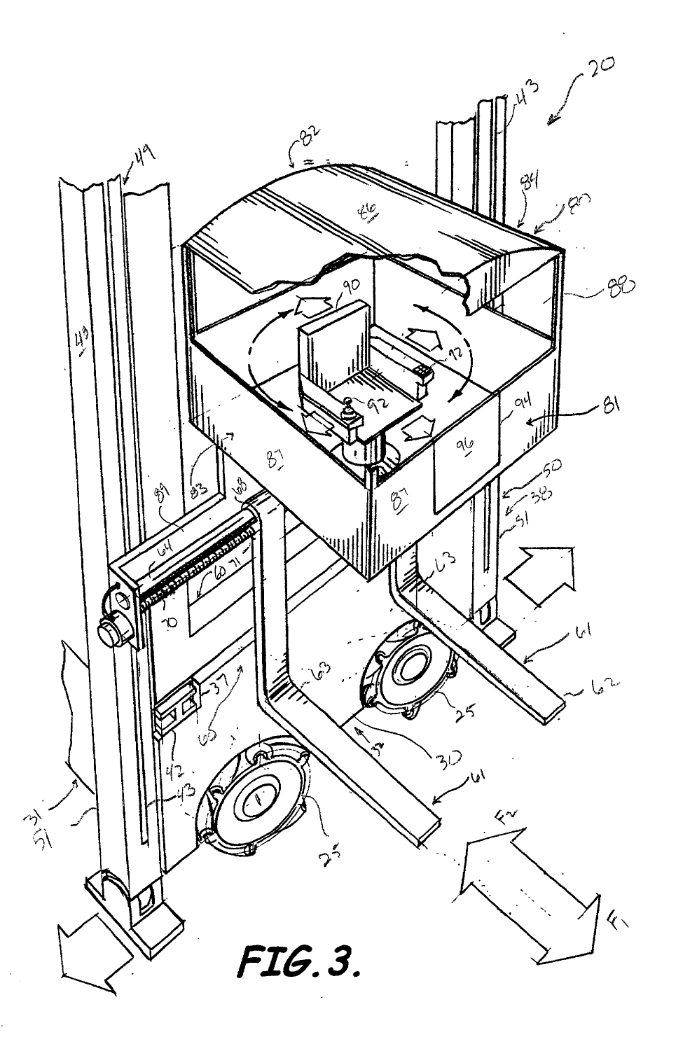

As illustrated in FIGS. 1 and 3, the base 30 preferably includes a first pair of spaced-apart fork lift frame guide rails 42. One of the first pairs of fork lift frame guide rails 42 is preferably connected to the first side of the base 36 and the other one of the first pair of fork lift frame guide rails 42 is preferably connected to the second side of the base 38. The first pair of fork lift frame guide rails 42 preferably extend along the first and second sides of the base 36, 38 between the front and the rear of the base 32, 34. More particularly, the first pair of fork lift frame guide rails 42 are preferably positioned along a top portion of the first and second sides of the base 36, 38, but can also be positioned along any portion of the first and second sides 36, 38, e.g., a medial portion of the first and second sides 36, 38 extending midway between the bottom 31 and the top 33. Further, the first pair of fork lift frame guide rails 42 can be mounted to outer peripheries of the respective first and second sides of the base 36, 38 or can be embedded therein. For example, the first and second sides of the base 36, 38 can advantageously include a groove formed therein. The first pair of fork lift frame guide rails 42 can then be positioned within the groove to connect to the respective first and second sides of the base 36, 38. As best illustrated in FIG. 1, the first pair of fork lift frame guide rails 42 are preferably positioned to matingly fit into an elongated notch 37 formed in a top portion of the first and second sides of the base 36, 38 so that the first pair of fork lift frame guide rails 42 are positioned flush with the first and second sides of the base 36, 38, i.e., the first pair of fork lift frame guide rails 42 do not extend beyond the limits of the first and second sides of the base 36, 38. This configuration advantageously provides the base 30 of the fork lift apparatus 20 with a streamlined design to thereby increase maneuverability.

The fork lift apparatus 20 of the present invention also preferably includes a fork lift frame 50 having a pair of spaced-apart and opposing side frame members 52. The side frame members 52 preferably extend upwardly from the base 30 and preferably include inner side frame members 55 and outer side frame members 56 connected to the inner side frame members 55. Each of the pair of side frame members 52 also preferably includes a front 46, a rear 47, and first and second sides 48, 49 extending between the front 46 and the rear 47, and are preferably positioned to slidably connect to one of the first pair of fork lift frame guide rails 42. More particularly, and as perhaps best illustrated in FIG. 1, the inner side frame members 55 are preferably slidably connected to the first pair of fork lift frame guide rails 42. The fork lift frame 50 is therefore adapted to slidably move between a retracted position F₁ and an extended position F₂ along the first pair of fork lift frame guide rails 42 connected to the base 30 of the fork lift apparatus 20. The retracted position F₁ of the fork lift frame 50 is preferably defined by the rear of the fork lift frame 47 being positioned adjacent the rear of the base 34. The extended position F₂ of the fork lift frame 50 is preferably defined by the rear of the fork lift frame 47 being positioned spaced-apart from the rear of the base 34.

As perhaps best illustrated in FIGS. 1 and 3, a bottom portion of each of the outer side frame members 56 is preferably positioned to matingly contact one of the first pair of fork lift frame guide rails 42 so that the fork lift frame 50 can be positioned between the extended and retracted positions F₁, F₂. For example, the first pair of fork lift frame guide rails 42 can be provided by an I-beam, as understood by those skilled in the art, that is mounted to the first and second sides of the base 36, 38. The bottom portion of each of the inner side frame members 55 can advantageously be a channel that is adapted to matingly receive portions of the I-beam so that the inner side frame members 55 are matingly connected to the first pair of fork lift frame guide rails 42.

The fork lift frame 50 also preferably includes a second pair of fork lift frame guide rails 43 that are preferably positioned to extend upwardly along the front of the respective pair of spaced-apart and opposing side frame members 52. As perhaps best illustrated in FIG. 1, the second pair of fork lift frame guide rails 43 are preferably positioned to extend upwardly along the front of the outer side frame members 56. The second pair of fork lift frame guide rails 43 can also be positioned to extend upwardly along the sides or rear of the outer side frame members 56. Each of the second pair of fork lift frame guide rails 43 can be metal rails that are mounted to outer peripheries of the outer side frame members 56 or can be embedded into the outer side frame members 56. The rails can be formed of a hard plastic or any other material that has strength properties suitable for withstanding heavy loads positioned thereon as understood by those skilled in the art.

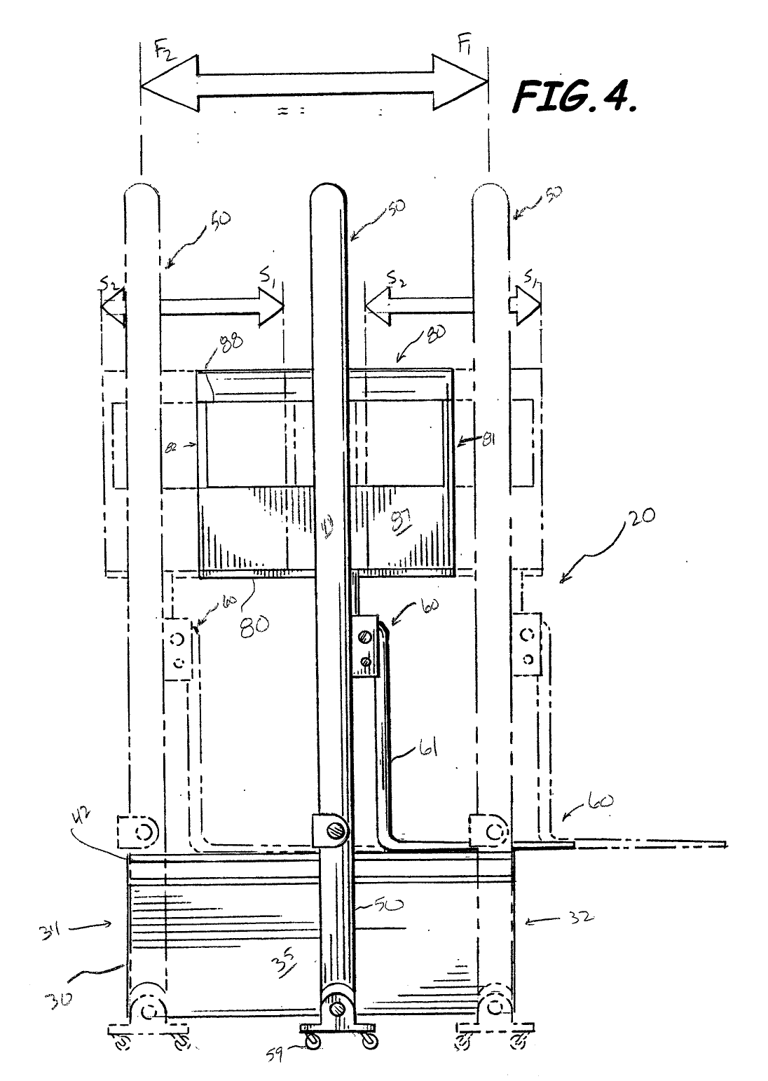

As illustrated in FIGS. 1 and 4, each one of the pair of side frame members 52 of the fork lift frame 50 preferably includes at least one wheel 59 connected to a bottom portion thereof. The at least one wheel 59 is advantageously adapted to move in forward, rearward, lateral, and transverse directions during forward, rearward, lateral, and transverse movement of the base 30 so that the movement of the base 30 is not limited by the movement of the fork lift frame 50, i.e., the fork lift frame 50 can be positioned to move in any direction because it will not be limited by the at least one wheel 59 connected to the bottom of the fork lift frame. The at least one wheel 59 also advantageously allows the fork lift frame 50 to be positioned between the extended and retracted positions F₁, F₂ during multi-directional movement of the fork lift apparatus 20. For example, regardless of whether the fork lift apparatus 20 is moving in the forward, rearward, lateral, or transverse directions, the fork lift frame 50 can advantageously be extended or retracted along portions of the base 30 due to the multi-directional capabilities of the at least one wheel 59 connected to the bottom portion of each of the pair of side frame members 52. The at least one wheel 59 can advantageously be provided by a caster, for example, or any other type of wheel that is capable of multidirectional movement as understood by those skilled in the art.

The fork lift apparatus 20 of the present invention further preferably includes a fork lift 60 slidably connected to and extending between the second pair of fork lift frame guide rails 43. The fork lift 60 preferably moves between a lowered position H₂ and an elevated position H₁ along the pair of side frame members 52. More particularly, as best illustrated in FIG. 1, the fork lift 60 is connected to and extends between the outer side frame members 56 to slidably move between the elevated and the lowered positions H₁, H₂. The fork lift 60 further advantageously moves between the elevated and lowered positions H₁, H₂ when the fork lift frame 50 is being positioned between the extended and retracted positions F₁, F₂. Therefore, the movement of the fork lift frame 50 and the movement of the fork lift 60 advantageously provide the fork lift apparatus 20 with at least two different and independent degrees of freedom of movement, e.g., the fork lift frame 50 moves between the extended and retracted positions F₁, F₂ and the fork lift 60 moves between the elevated and lowered positions H₁, H₂. Further, the movement of the fork lift 60 and the fork lift frame 50 can be accomplished simultaneously, thereby allowing the fork lift apparatus 20 to move a load between the extended and retracted positions F₁, F₂ and the elevated and lowered positions H₁, H₂ in one smooth and continuous move.

As illustrated in FIGS. 1 and 8-12, the fork lift 60 preferably includes a stationary fork guide 64 and a rotatable prong guide 70 extending between the pair of side frame members 52. The fork guide 64 preferably includes smooth outer peripheries and the prong guide 70 is preferably a grooved prong guide 70, i.e., the prong guide 70 includes a plurality of grooves 73 positioned to surround the outer peripheries of the prong guide 70. The prong guide 70 is preferably positioned to underlie the fork guide 64. The fork lift 60 also preferably includes a pair of spaced-apart prong members 61. As perhaps best illustrated in FIGS. 1, 2, 3 and 7, each of the pair of prong members 61 can advantageously have an “L-shape”, for example. The “L-shape” preferably includes a vertically extending back leg portion 66 and a horizontally extending bottom leg portion 67. The vertically extending back leg portion 66 of each of the pair of prong members 61 can advantageously include a proximal and a distal end portion 62, 63.

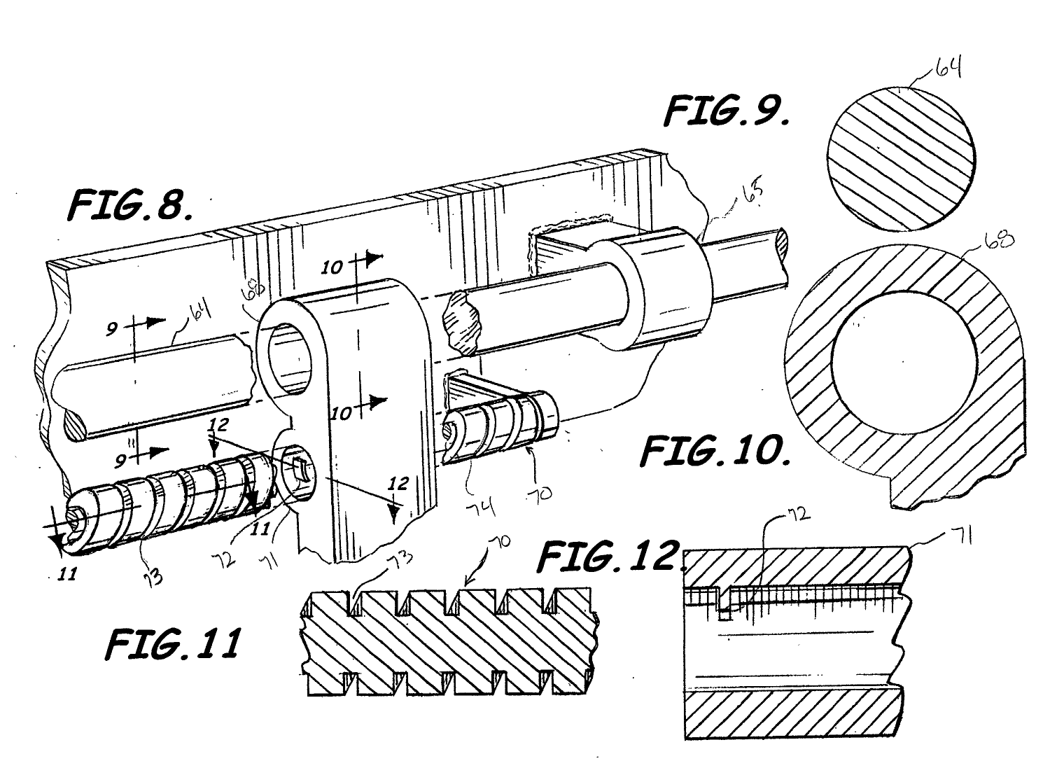

Each one of the pair of spaced-apart prong members preferably includes a fork guide connector 68 and a prong guide connector 71. The fork guide connector 68 and the prong guide connector 71 are preferably positioned along the vertically extending back portion 66 of each of the pair of prong members 61, as illustrated in FIGS. 1 and 8. As perhaps best illustrated in FIG. 10, the fork guide connector 68 preferably includes smooth inner peripheries and is positioned to slidably engage the fork guide 64 so that each of the pair of prong members 61 is slidably connected to the fork guide 64. The prong guide connector 61 preferably includes a prong guide connecting member 72 extending from an inner periphery of the prong guide connector 71 to engage the plurality of grooves 73 positioned on the outer peripheries of the prong guide 70 so that the prong guide connector 71 is positioned to matingly connect each of the pair of prong members 61 to the prong guide 70. The pair of prong members 61, therefore, slidably extend between an open position P₁ and a closed position P₂ responsive to the rotation of the prong guide 70. The prong guide 70 and the fork guide 64 can be made of a high strength metal material, for example, or any other type of material having strength properties and that can withstand continuous contact with the respective prong guide 70 and fork guide 64 as understood by those skilled in the art.

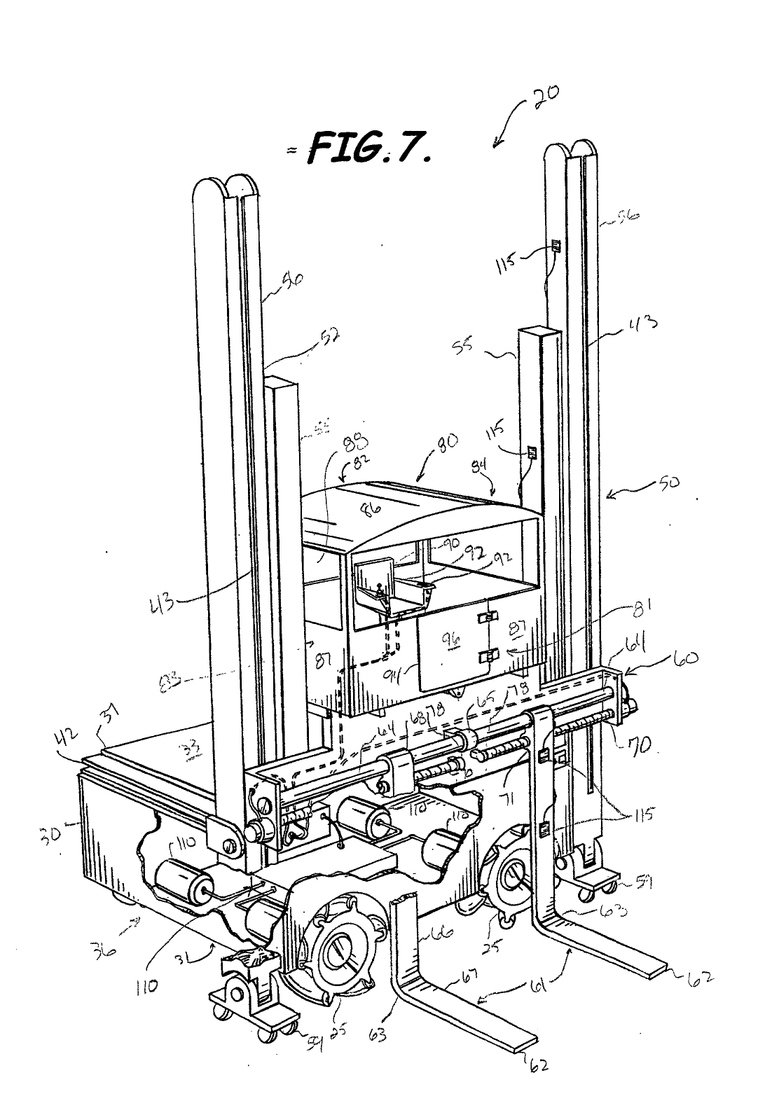

As illustrated in FIGS. 1 and 7, the prong guide 70 further preferably includes a first and a second prong guide 74, 76 positioned to abuttingly contact and extend outwardly from a stop member 78 positioned substantially adjacent the center of the fork lift apparatus 70. As also illustrated in FIGS. 1 and 7, the fork guide 64 also preferably includes a fork stop member 65 positioned along substantially the center of the fork guide 64. The first prong guide 74 is preferably positioned to extend between a first one of the pair of side frame members 52 and the stop member 78. Similarly, the second prong guide 76 is preferably positioned to extend between a second one of the pair of side frame members 52 and the stop member 78. The first prong guide 74 is advantageously adapted to receive the prong guide connector 71 of a first one of the pair of prong members 61 and the second prong guide 76 is advantageously adapted to receive the prong guide connector 71 of a second one of the pair of prong members 61. The first and second prong guides 74, 76 are preferably adapted to rotate independently of each other so that the pair of prong members 61 slidably move along the fork guide 64 independently of one another. Therefore, for example, the pair of prong members 61 can be positioned to extend inwardly towards one another or outwardly away from one another. The pair of prong members 61 can also be adapted to both simultaneously move towards either the first or second sides of the base 36, 38 of the fork lift apparatus, i.e., both to the left or both to the right. Further, one of the pair of prong members 61 can be positioned to move towards the first or second side of the base 36, 38 of the fork lift apparatus 20 while the other one of the pair of prong members 61 remains stationary, i.e., one prong member 61 moves to the left or right while the other prong member 61 remains stationary.

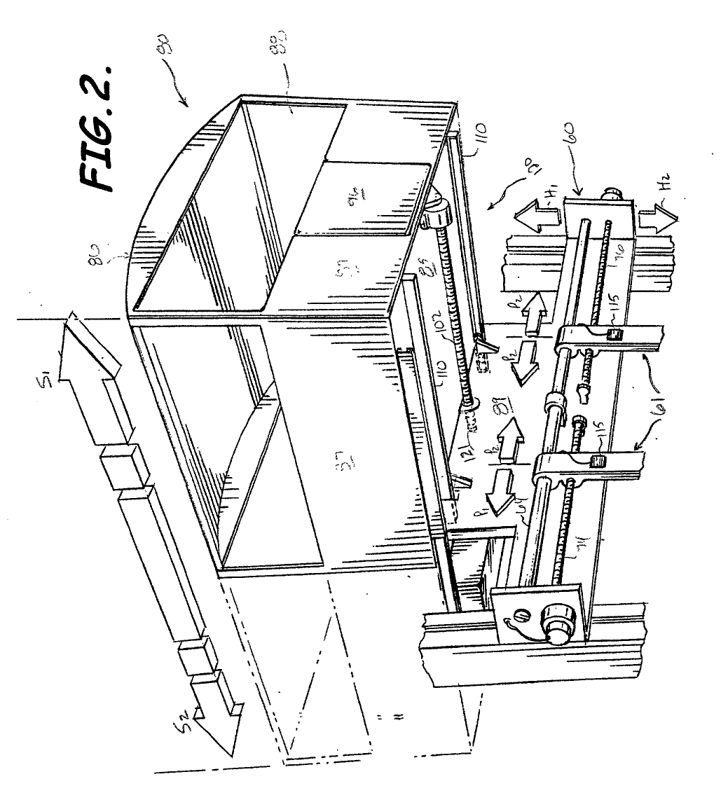

As perhaps best illustrated in FIGS. 2-3 and 13-14, the fork lift apparatus 20 of the present invention preferably includes an operator station 80 connected to the fork lift 60 to slidably extend between an extended position S₁ and a retracted position S₂. The operator station 80 preferably includes a front 81, a rear 82, and first and second sides 83, 84 extending between the front and rear 81, 82. The operator station 80 also preferably includes a bottom 85, a top 86, and a plurality of sidewalls 87 extending between the bottom 85 and the top 86. The plurality of sidewalls 87 preferably include a plurality of openings 88 so that an operator positioned in the operator station 80 is advantageously provided with an unobstructed view of the area surrounding the operator station 80. The extended position S₁ of the operator station 80 is preferably defined by the rear of the operator station 82 being positioned adjacent the front of the base 32. The retracted position S₂ of the operator station 80 is preferably defined by the rear of the operator station 82 being positioned adjacent the rear of the base 34.

The fork lift apparatus 20 of the present invention also preferably includes a plurality of wheels 25, e.g., omni-directional wheels, positioned adjacent the outer peripheries of the bottom of the base 31. As perhaps best illustrated in FIG. 1, each of the plurality of omni-directional wheels 25 are preferably adapted to move the fork lift apparatus 20 in forward, rearward, lateral, and transverse or oblique directions. The plurality of omni-directional wheels 25 preferably includes four spaced-apart omni-directional wheels 25 positioned along opposing bottom corner end portions of the base 30. Although four omni-directional wheels 25 are preferred, any number of omni-directional wheels 25 can be used and positioned along the bottom of the base 31 so that the base 30 can be adapted to move in forward, rearward, lateral, and transverse or oblique directions. The omni-directional wheels 25 can advantageously be made of a molded hard plastic material, a metal material, or any other type of material having high strength properties and low deformation properties as understood by those skilled in the art. A more detailed description of the omni-directional wheels 25 can be found in U.S. Pat. No. 6,134,734 by the same inventor of the present invention and titled Aircraft Maintenance Apparatus and Method of Maintaining Aircraft, and U.S. patent application Ser. No.______, filed on Oct. 10, 2001 also by the same inventor of the present invention and titled Omni-Directional Wheel and Associated Methods. Both the issued patent and pending application are incorporated herein by reference in their entireties.

As perhaps best illustrated in FIGS. 1-2, the operator station 80 is preferably positioned to connect to a top portion of the fork lift 60 so that the operator station 80 can be slidably positioned between the extended and retracted positions S₁, S₂. The top portion of the fork lift 60 can, for example, include an operator station extension 89 that extends upwardly from the top portion of the fork lift 60 to connect to the bottom of the operator station 85. As perhaps best illustrated in FIG. 2, the operator station can also advantageously include a pair of operator station guide rails 100 positioned to extend along bottom outer peripheries of the fork lift 70 and extend between the front to the rear of the operator station 81, 82. Each of the pair of operator station guide rails 100 can advantageously be positioned to slidably engage one operator station guide rail receiver 69 positioned along a top portion of the operator station extension 89. As also illustrated in FIG. 2, the operator station 80 can also include an operator station guide rod 101 adapted to rotatably engage an operator station guide rod receiver 102 positioned along the top portion of the operator station extension 89. The operator station guide rod 101 can advantageously be grooved, for example, and the operator station guide rod receiver 102 can advantageously include a follower, for example, that is positioned to engage the grooved operator station guide rod 101. The operator station guide rod 101 is adapted to rotate in first and second predetermined directions. Therefore, as the operator station guide rod 101 is rotated in the first or second predetermined directions, the operator station 80 is moved between the extended and the retracted positions S₁, S₂.

The operator station 80 preferably includes a controller 92 positioned to control the movement of the base 30 in the forward, rearward, lateral, and transverse directions, the movement of the fork lift frame 50 between the extended and retracted positions F₁, F₂, the movement of the fork lift 60 between the elevated and lowered positions H₁, H₂, the movement of the prong members 61 between the open and the closed positions P₁, P₂, and the movement of the operator station 80 between the extended and retracted positions S₁, S₂. As illustrated in FIGS. 3 and 7, the controller 92 can advantageously include a user interface provided by a stick, e.g., a joystick, or any other type of device that is responsive to the operator to control the operation of the fork lift apparatus 20 as understood by those skilled in the art.

The user interface can advantageously include various positions that represent the desired movement of the fork lift apparatus 20. For example, when the user interface is positioned in the forward position, the fork lift apparatus 20 can be positioned to move forward. Likewise, when the user interface is retracted to a rearward position, the fork lift apparatus 20 can be positioned in a rearward direction. The user interface of the controller 92 can also advantageously be provided by a combination of a forward/rearward lever and a wheel, for example, to provide a combination of forward/rearward movement and turning capabilities thereby providing the operator with the ability to direct the base 30 of the fork lift apparatus 20 in the forward, rearward, lateral, and transverse directions. The controller 92 can also advantageously allow the operator to control, the extension and retraction of the fork lift frame 50, the elevation of the fork lift 60, and the extension and retraction of the operator station 80.

As illustrated in FIG. 3, the operator station 80 also preferably includes an operator seat 90. The operator seat 90 can advantageously be moved into various positions so that the operator is positioned to face the direction of movement of the fork lift apparatus 20. For example, when the fork lift apparatus 20 is positioned to move in the forward direction, the operator seat 90 can advantageously be positioned to face forwardly so that the operator is facing in the direction of movement of the fork lift apparatus 20. Similarly, when the fork lift apparatus 20 is positioned to move in a lateral or transverse direction, the position of the operator seat 90 can advantageously be changed so that the operator is positioned to face the direction of movement of the fork lift apparatus 20. The operator seat 90 can include a manual seat positioner, such as a lever, for example, that, when engaged, allows the operator seat 90 to be moved in various positions. The operator seat 90 can also advantageously include an automatic seat positioner that automatically changes the position of the operator seat depending on the direction of movement of the fork lift apparatus 20. This advantageously insures that the operator is always facing in the same direction as the direction of movement of the fork lift apparatus, thereby eliminating hazards presented by the operator not visualizing the direction of movement of the; fork lift apparatus. The operator seat 90 can further advantageously have the user interface connected thereto. For example, the user interface can be positioned adjacent one of the arms of the operator seat 90. This advantageously allows an operator ready access to the user interface.

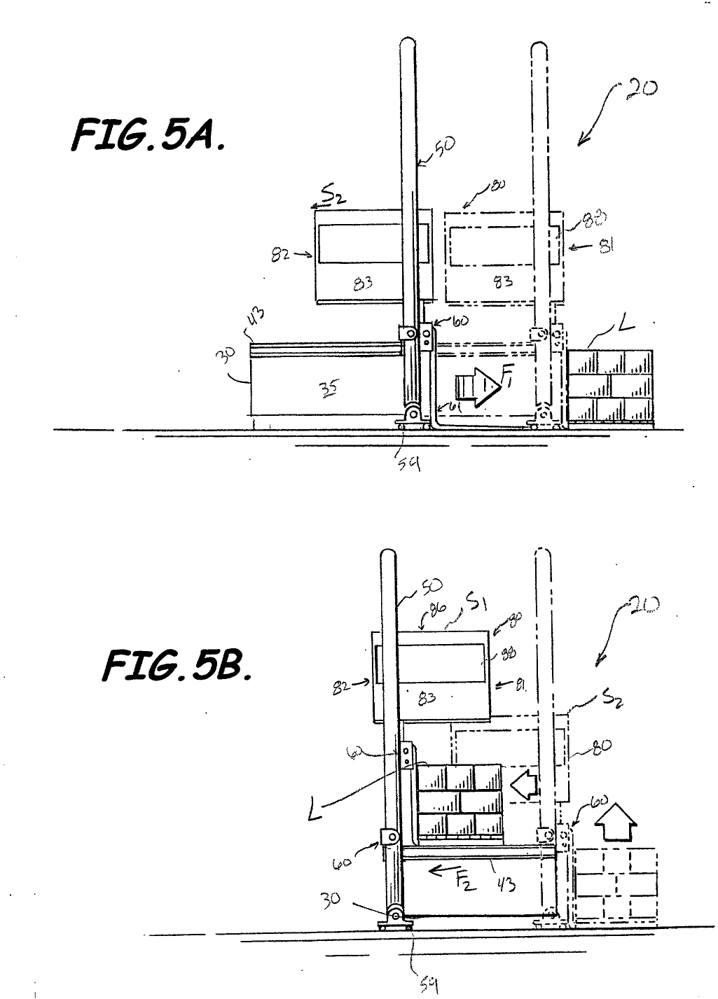

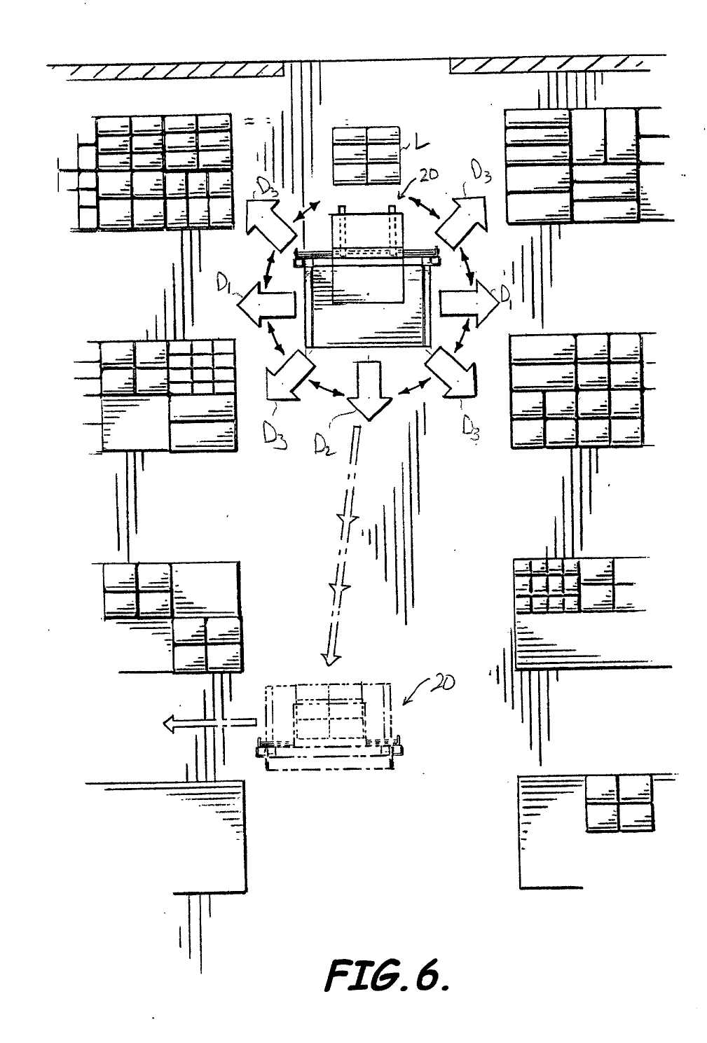

As illustrated in FIG. 7, the fork lift apparatus 20 of the present invention further preferably includes a drive assembly 110 connected to the base 30, the fork lift frame 50, the fork lift 60, the plurality of omni-directional wheels 25, the operator station 80, the prong members 61 and the controller 92. As will be readily understood by those skilled in the art, the drive assembly 110 is preferably adapted to drive the fork lift frame 50 between the extended and retracted positions F₁ F₂, as illustrated in FIG. 4, the fork lift 60 between the elevated and lowered positions H₁, H₂, as illustrated in FIGS. 5A-5B, the operator station 80 between the extended and retracted positions S₁, S₂, as illustrated in FIG. 4, the prong members 61 between the open and the closed positions P₁, P₂, as illustrated in FIG. 2, and the plurality of omni-directional wheels 25 so that the base moves in forward, rearward, lateral and transverse directions, as best illustrated in FIG. 6. Each of the fork lift frame 50, the fork lift 60, the plurality of omni-directional wheels 25, the prong members 61, and the operator station 80 are driven independently on one another responsive to the controller 92. The drive assembly 110 and the controller 92 are preferably positioned in communication with one another. The communication between the drive assembly 110 and the controller 92 can advantageously be a hard wire connection, for example, or radio frequency, infrared, or any other type of communication as understood by those skilled in the art. When the drive assembly 110 receives a signal from the controller 92, that signal is then transmitted to the fork lift frame 50, the fork lift 60, the operator station 90, and the plurality of omni-directional wheels 25 to thereby move the fork lift frame 50 between the extended and retracted positions F₁, F₂, the fork lift 60, between the elevated and lowered position H₁, H₂, the operator station 80 between the extended and the retracted positions S₁, S₂, and to rotate the plurality of omni-directional wheels 25 independently and at a predetermined rate to thereby move the base 30 in the forward, rearward, lateral, and transverse directions.

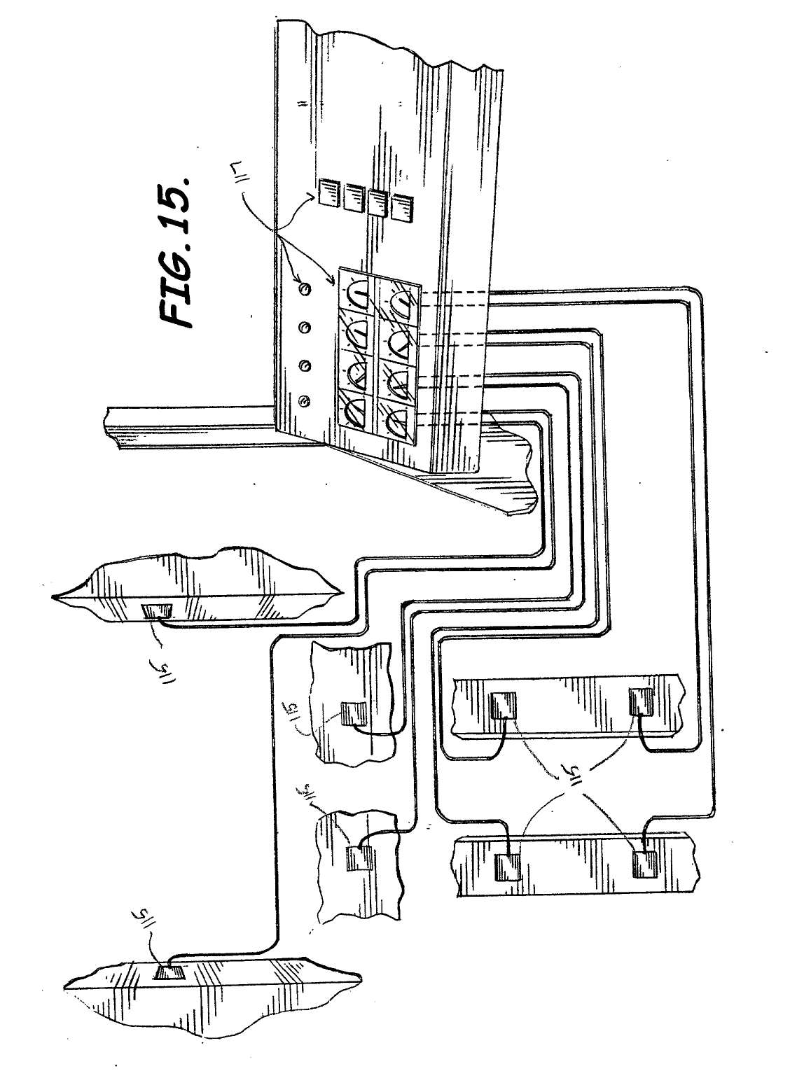

As illustrated in FIGS. 1, and 13-14, the fork lift apparatus 20 of the present invention preferably includes a weight balance meter 115 positioned in communication with the controller to meter weight distributed on the fork lift apparatus 20. The weight distribution that is metered by the weight balance meter 115 is not limited to the load positioned on the fork lift apparatus 20, but also includes metering the weight distribution as the fork lift frame 50 is positioned between the extended and retracted positions F₁, F₂, as the fork lift 60 is positioned between the elevated and lowered positions H₁, H₂ and as the base 30 is positioned in the forward, rearward, lateral, and transverse directions. The weight balance meter 115 advantageously detects unbalanced weight distribution on the fork lift apparatus 20 to thereby advantageously avoid the hazards associated with the fork lift apparatus 20 tipping of the load positioned on the fork lift apparatus 20. As best illustrated in FIG. 15, the weight balance meter 115 is preferably positioned in communication with a plurality of weight balance meter instruments 117 positioned in the operator station 80, as understood by those skilled in the art, so that the operator can advantageously readily observe the weight distribution on the fork lift apparatus 20. The weight balance meter instruments 117 can advantageously include gauges or indicator lights indicating the weight distribution of the fork lift apparatus 20, or any other type of gauge that alerts the operator of the fork lift apparatus 20 of an unbalanced weight distribution condition.

As perhaps best illustrated in FIGS. 7, 13 and 15 the weight balance meter 115 can advantageously be provided by a strain gauge, for example, or any other type of meter capable of detecting a shift in the weight balance on the fork lift apparatus 20 due to a number of factors, e.g., a shift in the position of the load L when positioned on the prong members 61, the elevation of the fork lift 60, the position of the fork lift frame 50, or the position of the operator station 80. Another type of weight balance meter 115 can advantageously include a plurality of levels positioned along outer peripheries of the fork lift apparatus 20 as understood by those skilled in the art. A level can advantageously be used to meter whether or not the fork lift apparatus is level when the load is positioned thereon. The strain gauge is preferably positioned to measure strain applied to the fork lift apparatus 20 by the predetermined load and by the position of the base 30, the fork lift 60, and the fork lift frame 50. The measured strain is used to determine the weight balance distribution of the load L on the fork lift apparatus 20.

The weight balance meter 115 can advantageously include a sensor, an actuator, and a transducer. The sensor preferably provides a usable, electrical output signal in response to a specified measurement, e.g., a measurement of strain placed upon the fork lift 60, the fork lift frame 50, or the prong members 61, for example. The actuator preferably converts an electrical signal to an action. For example, the action can be provided by moving the operator station 80 between the extended and retracted positions S₁, S₂. The transducer is preferably a device that transforms one form of signal or energy into another form as understood by those skilled in the art. The term transducer can be used to include both sensors and actuators. The weight balance meter 115 can advantageously be provided by a strain gauge such as a microelectromechanical device or system (MEMS) as understood by those skilled in the art. More particularly, the MEMS can advantageously be provided by a micro sensor, such as an integrated sensor, a monolithic integrated sensor, a hybrid integrated sensor, all referred to as package sensors, or any other types of sensors as understood by those skilled in the art. The packaged sensors are advantageous because they not only transduce the sensed measurement into an electrical signal, but also have other signal processing and decision making capabilities. Packaged sensors are also referred to as intelligent or smart sensors. When using packaged sensors, the principles that are preferably used to sense strain are piezoelectricity, piezoresistivity, and captive or inductive impedance, as understood by those skilled in the art. As best illustrated in FIGS. 1 and 13-14, the sensors are preferably positioned along portions of the fork lift frame 50, the prong members 61, motors positioned to elevate and lower the fork lift 60 and operator station 80, and to move the operator station 80 between the extended and retracted positions S₁, S₂. The sensors can advantageously measure any deformity of the fork lift 60, the fork lift frame 50, the prong members 61 or the operator station 80 caused by excessive strain applied to the fork lift apparatus 20 by the load L. Further, the sensors can also detect excess strain on the motors when moving portions of the fork lift apparatus 20 having the load L positioned thereon.

The fork lift apparatus 20 of the present invention further preferably includes a weight distributor 120 positioned in communication with the operator station 80 and the controller 92 to distribute weight throughout the fork lift apparatus 20. As illustrated in FIG. 2, the weight distributor 120 can advantageously be provided by an operator station positioner 121. The operator station positioner 121 preferably includes the operator station guide rails 100, the operator station guide rod 101, and the operator station guide receiver 102, and is preferably responsive to the controller 92. The weight distributor 120 can also advantageously be provided by a combination of the operator station positioner 121 and a counter weight extension 130 as illustrated in FIGS. 1314. The counter weight extension 130 is preferably positioned to extend and retract from a lower rear outer periphery of the operator station 80. The counter weight extension 130 preferably includes a counter weight extension frame 131 and a counter weight 132 connected thereto. The counter weight extension 130 is preferably adapted to move between an extended and a retracted position C₁, C₂ The counter weight extension 130 is preferably positioned to slidably engage a pair of counter weight extension tracks 133 connected to the bottom of the operator station 85. The pair counter weight extension tracks 133 preferably include a front and a rear, extend along the first and second sides of the operator station 83, 84 between the front and the rear 81, 82, and each include a pair of track stops positioned adjacent the front and rear so that the motion between the extended and retracted positions C₁, C₂ can be limited.

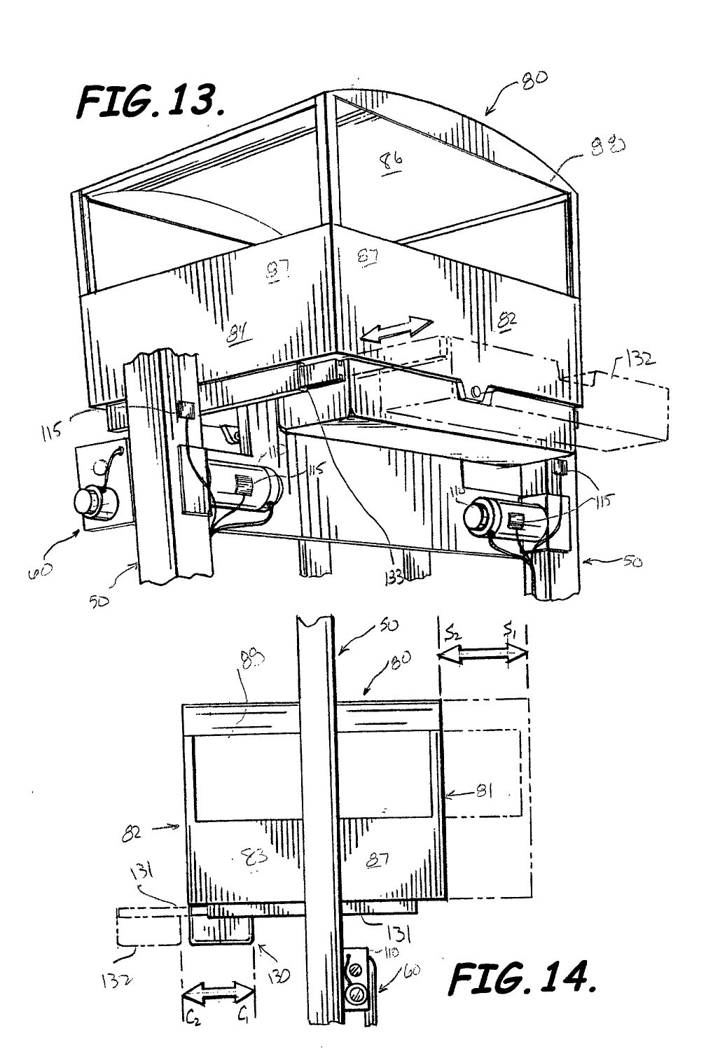

The counter weight extension 131 is further preferably positioned so that it will not obstruct the motion of the operator station 80 between the extended and retracted positions S₁, S₂. For example, as perhaps best illustrated in FIGS. 13 and 14, when the operator station 80 is positioned between the extended and retracted positions S₁, S₂, the counter weight extension 131 will not act to limit the full range of possible motion between the extended and retracted positions S₁, S₂.

The weight distributor 120 is preferably responsive to the weight balance meter 115 so that the weight of the operator station 80 can preferably be used as a counterbalance to the weight of the load L positioned on the fork lift apparatus 20. For example, when the prong members 61 engage and lift a load L, and the fork lift 60 is elevated to lift the load L, the weight of the load L applies a moment to the fork lift apparatus 20, as understood by those skilled in the art. Since the fork lift apparatus 20 is not fixed to a support surface, the applied moment, if large enough, can possibly cause the fork lift apparatus 20 to lean towards the direction of the moment, e.g., the fork lift apparatus 20 will engage and lift the load along the front of the base and therefore, the moment applied to the fork lift apparatus 20 will cause the fork lift apparatus 20 to lean forward. If, however, strong enough moment is applied and no counter-moment is applied to the fork lift apparatus 20, i.e., a load applied to a side opposite the load L lifted by the fork lift 60, the fork lift apparatus 20 can possibly become unbalanced to the point of tipping over. Therefore, the weight balance meter 115 and the weight distributor 120 of the fork lift apparatus 20 combiningly apply a counter-moment to the fork lift apparatus 20 to prevent a shift in the balance of the fork lift apparatus 20 as the load L is engaged and lifted. More particularly, as best illustrated in FIGS. 2 and 13-15, the weight balance meter 115 detects any shift in the balance of the fork lift apparatus and through communication with the controller 92, takes measures to avoid the hazards associated with the fork lift apparatus 20 tipping.

As previously noted, a shift in balance can occur from the amount of the load positioned on the fork lift apparatus 20 or the positioning of that load. After the weight balance meter 115 detects a shift in the weight balance of the fork lift apparatus 20, the weight balance is preferably displayed on the weight balance meter instruments 117 positioned in the operator station 80 to indicate the shift in weight balance to the operator. The operator can then use the weight distributor 120 to balance the weight of the fork lift apparatus 20. The weight balance distributor 120 can also advantageously automatically balance the weight of the fork lift apparatus 20, e.g., provide a counter balance or a counter-moment without the need for the operator to control the amount or position of the counter balance. As noted above and as illustrated in FIGS. 2 and 13-14, the counter balance or counter-moment applied to the fork lift apparatus 20 is preferably provided by the operator station 80 being positioned between the extended and the retracted positions S₁, S₂. As also illustrated in FIGS. 13-14, the counter balance or counter-moment can also advantageously be enhanced by a counter weight extension positioned to extend from the lower rear outer periphery of the operator station.

As perhaps best illustrated in FIG. 6, the present invention also advantageously includes a method of positioning a load L within a predetermined area using a fork lift apparatus 20 having a base 30 with a longitudinal axis. The method preferably includes longitudinally moving the fork lift apparatus 20 in a first predetermined direction D₁ along a longitudinal axis of the predetermined area so that the longitudinal axis of the base 30 is positioned substantially parallel to the longitudinal axis of the area. As best illustrated in FIG. 5B, the method also preferably includes extending a fork lift frame 50 so that a fork lift 60 connected thereto is positioned to engage and lift the load L. The method further preferably includes laterally moving the fork lift apparatus 20 in a second predetermined direction D₂ so that the longitudinal axis of the base is positioned substantially perpendicular to the longitudinal axis of the area.

The method of positioning the load L further preferably includes diagonally moving the fork lift apparatus 20 in a third predetermined direction D₃ so that the longitudinal axis of the base 30 is positioned transverse to the longitudinal axis of the area. The method still further preferably includes elevating and lowering the fork lift 60 having the load L positioned thereon when the fork lift apparatus 20 is moved in the first, second, or third predetermined directions D₁, D₂, D₃, and extending and retracting the fork lift frame 50 when the fork lift apparatus 20 is moved in the first, second, or third predetermined directions D₁, D₂, D₃. The method also preferably includes retracting the fork lift frame 50 and lowering the fork lift 60 having the load L positioned thereon so that the load L is positioned to rest on the base 30 when the fork lift apparatus 20 is stationary or moved in the first, second, or third predetermined directions D₁, D₂, D₃. The method further preferably includes counter-balancing the load L positioned on the fork lift 60 by laterally extending and retracting an operator station 80 along the fork lift frame 50 and extending and retracting the operator station 80 when the fork lift apparatus is moved in the first, second, or third predetermined directions D₁, D₂, D₃.

As perhaps best illustrated in FIGS. 5A-5B, the present invention also advantageously preferably includes a method of balancing a fork lift apparatus 20 having a base 30. The method preferably includes extending a fork lift frame 50 having a fork lift 60 connected thereto to engage and lift a load L and counter-balancing the load L positioned on the fork lift 60 by laterally extending and retracting an operator station 80 along the fork lift frame 50. The method of balancing the fork lift apparatus 20 also preferably includes extending and retracting each one of a pair of prong members 61 positioned to extend outwardly from the fork lift 60 between an open and a closed position P₁, P₂, so that the prong members 61 of the fork lift 60 are positioned to engage and lift the load L in a balanced manner. The method of balancing the fork lift apparatus 20 further preferably includes longitudinally moving the fork lift apparatus 20 in a first predetermined direction D₁ along a longitudinal axis of a predetermined area so that a longitudinal axis of the base 30 is positioned parallel to the longitudinal axis of the predetermined area.

The method of balancing the fork lift apparatus 20 still further preferably includes laterally moving the fork lift apparatus in a second predetermined direction D₂ so that the longitudinal axis of the base 30 is positioned substantially perpendicular to the longitudinal axis of the predetermined area and diagonally moving the fork lift apparatus in a third predetermined direction D₃ so that the longitudinal axis of the base 30 is positioned transverse to the longitudinal axis of the predetermined area. The method of balancing the fork lift apparatus 20 also preferably includes elevating and lowering the fork lift 60 having the load L positioned thereon when the fork lift apparatus 20 is moved in the first, second, or third predetermined directions D₁, D₂, D₃. The method further preferably includes extending and retracting the fork lift frame 50 when the fork lift apparatus 20 is moved in the first, second, or third predetermined directions D₁, D₂, D₃, and retracting the fork lift frame 50 and lowering the fork lift 60 having the load L positioned thereon so that the load L is positioned to rest on the base when the fork lift apparatus 20 is stationary or moved in the first, second, or third predetermined directions D₁, D₂, D₃. The method still further preferably includes counter-balancing the load L positioned on the fork lift 60 by laterally extending and retracting an operator station 80 along the fork lift frame 50 and extending and retracting the operator station 80 when the fork lift apparatus 20 is moved in the first, second, or third predetermined directions D₁, D₂, D₃.

In the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification and as defined in the appended claims.

That claimed is:

1. A fork lift apparatus comprising:
a base having a front, a rear, and first and second sides extending between the front and the rear, the first side being positioned substantially opposite the second side and having a first pair of spaced-apart fork lift frame guide rails, one of the fork lift frame guide rails connected to the first side of the base and the other fork lift frame guide rail connected to the second side of the base so that the frame guide rails extend along the first and second sides between the front and the rear of the base;
a fork lift frame having a pair of spaced-apart and opposing side frame members each positioned to slidably connect to one of the first pair of fork lift frame guide rails, the fork lift frame adapted to slidably move between a retracted position and an extended position and further comprising a second pair of fork lift frame guide rails positioned to extend upwardly along the respective pair of spaced-apart and opposing side frame members;
a fork lift slidably connected to and extending between the second pair of fork lift frame guide rails so that the fork lift moves between a lowered position and an elevated position along the pair of spaced-apart and opposing side frame members;
an operator station connected to the fork lift to slidably extend between a retracted position and an extended position, the operator station having a controller positioned to control the movement of the base, the movement of the fork lift frame between the extended and retracted positions, the movement of the fork lift between the lowered and the elevated positions, and the movement of the operator station between the extended and retracted positions; and
a drive assembly connected to the base, the fork lift frame, the fork lift, the operator station and the controller to drive the fork lift frame between the extended and retracted positions, the fork lift between the elevated and lowered positions, and the operator station between the extended and retracted positions independently of one another responsive to the controller.

2. A fork lift apparatus as defined in claim 1, further comprising a plurality of omni-directional wheels connected to a bottom portion of the base so that the base moves in forward, rearward, lateral, and transverse directions.

3. A fork lift apparatus as defined in claim 2, wherein each one of the pair of side frame members include a front and a rear and at least one wheel connected to a bottom portion thereof adapted to move in forward, rearward, lateral, and transverse directions during forward, rearward, lateral, and transverse movement of the base so that the movement of the base is not limited by the fork lift frame and so that the fork lift frame can be readily positioned between the extended and retracted positions during multi-directional movement of the fork lift apparatus.

4. A fork lift apparatus as defined in claim 3, wherein the fork lift further comprises a stationary fork guide and a rotatable prong guide extending between each of the pair of spaced-apart and opposing side frame members, and a pair of spaced-apart prong members each having a fork guide connector and a prong guide connector, the fork guide connector positioned to slidably connect each of the pair of prong members to the fork guide, the prong guide connector positioned to matingly connect each of the pair of prong members to the prong guide so that the pair of prong members slidably extend between an open position and a closed position responsive to the rotation of the prong guide.

5. A fork lift apparatus as defined in claim 4, wherein the controller is further positioned to control the multi-directional movement of the base provided by the plurality of omni-directional wheels and the movement of the prong members between the open and closed positions and wherein the drive assembly is further connected to the plurality of omni-directional wheels and the prong members to drive the plurality of omni-directional wheels in multiple directions and the prong members between the open and closed positions, the omni-directional wheels and the prong members moving independently of one another and responsive to the controller.

6. A fork lift apparatus as defined in claim 5, wherein the retracted position of the fork lift frame is further defined by the rear of the fork lift frame being positioned adjacent the rear of the base and wherein the extended position of the fork lift frame is further defined by the rear of the fork lift frame being positioned spaced-apart from the rear of the base.

7. A fork lift apparatus as defined in claim 6, wherein the operator station further comprises a front, a rear, and first and second sides extending between the front and the rear and wherein the extended position of the operator station is further defined by the rear of the operator station being positioned adjacent to the front of the base and wherein the retracted position of the operator station is further defined by the rear of the operator station being positioned adjacent the rear of the base.

8. A fork lift apparatus as defined in claim 7, further comprising a weight balance meter positioned in communication with the controller to meter weight distributed on the fork lift apparatus as the fork lift frame is positioned between the retracted and extended positions, as the fork lift is positioned between the elevated and lowered positions and as the base is positioned in the forward, rearward, lateral, and transverse directions so as to detect unbalanced weight distribution on the fork lift apparatus.

9. A fork lift apparatus as defined in claim 8, wherein the weight balance meter further comprises at least one strain gauge positioned to measure strain applied to the fork lift apparatus by a load positioned thereon and by the position of the base, the fork lift and the fork lift frame between the respective lowered and elevated positions and extended and retracted positions to thereby detect unbalanced weight distribution on the fork lift apparatus.

10. A fork lift apparatus as defined in claim 9, further comprising a weight distributor positioned in communication with the operator station and the controller to distribute weight throughout the fork lift apparatus, the weight distributor further comprising an operator station positioner to position the operator station between the retracted and extended positions responsive to the weight balance meter so that the weight of the operator station is used as a counter balance to the weight of the load.

11. A fork lift apparatus as defined in claim 10, wherein the fork guide further comprises substantially smooth outer peripheries and wherein the prong guide is a grooved prong guide positioned to underlie the fork guide so that the fork guide connector is positioned to slidably engage the fork guide, and the prong guide connector is positioned to matingly engage the prong guide to move the pair of prong members between the open and closed positions.

12. A fork lift apparatus as defined in claim 11, wherein the prong guide connector further comprises a prong guide connecting member extending from an inner periphery of the prong guide connector to engage a plurality of grooves positioned on outer peripheries of the grooved prong guide so that each of the pair of prong members extend between the opened and closed positions responsive to the rotation of the grooved prong guide.

13. A fork lift apparatus as defined in claim 12, wherein the prong guide further comprises a first and a second prong guide positioned to abuttingly contact and extend outwardly from a stop member positioned substantially adjacent the center of the fork lift apparatus so that the first prong guide is positioned to extend between a first one of the pair of side frame members and the stop member, and the second prong guide is positioned to extend between a second one of the pair of side frames members and the stop member, the first prong guide adapted to receive the prong guide connecting member of a first one of the pair of prong members and the second prong guide adapted to receive the prong guide connecting member of a second one of the pair of prong members, the first and second prong guides adapted to rotate independently of each other so that the first and second prong members slidably move along the fork guide independently of each other.

14. A fork lift apparatus comprising:
a base having a front, a rear, and first and second sides extending between the front and the rear, the first side being positioned substantially opposite the second side and having a first pair of spaced-apart fork lift frame guide rails, one of the fork lift frame guide rails connected to the first side of the base and the other fork lift frame guide rail connected to the second side of the base;
a fork lift frame having a pair of spaced-apart and opposing side frame members, each having a front and a rear and positioned to slidably connect to one of the first pair of fork lift frame guide rails, the fork lift frame adapted to slidably move between a retracted position and an extended position and further comprising a second pair of fork lift frame guide rails each positioned to extend upwardly along the respective pair of spaced-apart and opposing side frame members;
a fork lift slidably connected to and extending between the second pair of fork lift frame guide rails so that the fork lift moves between a lowered position and an elevated position along the pair of spaced-apart and opposing side frame members;
a plurality of omni-directional wheels connected to a bottom portion of the base so that the base moves in forward, rearward, lateral, and transverse directions;
a controller connected to the base, the omni-directional wheels, the fork lift frame and the fork lift positioned to control the multi-directional movement of the plurality of omni-directional wheels, the movement of the fork lift frame between the extended and retracted positions and the movement of the fork lift between the elevated and lowered positions; and
a drive assembly connected to the base, the fork lift frame, the fork lift, the plurality of omni-directional wheels, and the controller to drive the fork lift apparatus in the forward, rearward, lateral, and transverse directions, the fork lift frame between the extended and retracted positions, and the fork lift between the elevated and retracted positions, each moving independently of one another and responsive to the controller.

15. A fork lift apparatus as defined in claim 14, wherein the fork lift further comprises a stationary fork guide and a rotatable prong guide, each extending between the pair of spaced-apart and opposing side frame members, and a pair of spaced-apart prong members each having a fork guide connector and a prong guide connector, the fork guide connector positioned to slidably connect each of the pair of prong members to the fork guide, the prong guide connector positioned to matingly connect each of the pair of prong members to the prong guide so that the pair of prong members slidably extend between an open position and a closed position responsive to the rotation of the prong guide.

16. A fork lift apparatus as defined in claim 15, further comprising an operator station slidably connected to the fork lift to extend between a retracted position and an extended position, wherein the controller is further positioned to control the movement of the prong members between the open and the closed positions and the movement of the operator station between the extended and the retracted positions, and wherein the drive assembly is further connected to the operator station and the prong members to drive the operator station between the extended and retracted positions and the prong members between the open and the closed positions, the operator station and the prong members each moving independently of one another and responsive to the controller.

17. A fork lift apparatus as defined in claim 16, wherein each one of the pair of side frame members include a front and a rear and at least one wheel connected to a bottom portion thereof, the at least one wheel being adapted to move in forward, rearward, lateral, and transverse directions during forward, rearward, lateral, and transverse movement of the base so that the movement of the base is not limited by the fork lift frame and so that the fork lift frame can be readily positioned between the extended and retracted positions during multi-directional movement of the fork lift apparatus.

18. A fork lift apparatus as defined in claim 17, wherein the retracted position of the fork lift frame is further defined by the rear of the fork lift frame being positioned adjacent the rear of the base and wherein the extended position of the fork lift frame is further defined by the rear fork lift frame being positioned spaced-apart from the rear of the base.

19. A fork lift apparatus as defined in claim 18, wherein the operator station further comprises a front, a rear, and first and second sides extending between the front and rear, and the extended position of the operator station is further defined by the rear of the operator station being positioned adjacent to the front of the base and wherein the retracted position of the operator station is further defined by the rear of the operator station being positioned adjacent the rear of the base.

20. A fork lift apparatus as defined in claim 19, further comprising a weight balance meter positioned in communication with the controller to meter weight distributed on the fork lift apparatus as the fork lift frame is positioned between the retracted and extended positions and as the fork lift is positioned between the elevated and lowered positions and as the base is positioned in forward, rearward, lateral, and transverse directions so as to detect unbalanced weight distribution on the fork lift apparatus.

21. A fork lift apparatus as defined in claim 20, wherein the weight balance meter further comprises at least one strain gauge positioned to measure strain applied to the fork lift apparatus by a load positioned thereon and by the position of the base, the fork lift and the fork lift frame between the respective lowered and elevated positions and extended and retracted positions to thereby detect unbalanced weight distribution on the fork lift apparatus.

22. A fork lift apparatus as defined in claim 21, further comprising a weight distributor positioned in communication with the operator station and the controller to distribute weight throughout the fork lift apparatus, the weight distributor further comprising an operator station positioner to position the operator station between the retracted and extended positions responsive to the weight balance meter so that the weight of the operator station is used as a counter balance to the weight of the load.

23. A fork lift apparatus as defined in claim 22, wherein the fork guide further comprises substantially smooth outer peripheries and wherein the prong guide is a grooved prong guide positioned to underlie the fork guide so that the fork guide connector is positioned to slidably engage the fork guide, and the prong guide connector is positioned to matingly engage the prong guide to move the pair of prong members between the open and closed positions.

24. A fork lift apparatus as defined in claim 23, wherein the prong guide connector further comprises a prong guide connecting member extending from an inner periphery of the prong guide connecting member to engage a plurality of grooves positioned on outer peripheries of the grooved prong guide so that each of the pair of prong members extend between the opened and closed positions responsive to the rotation of the grooved prong guide.

25. A fork lift apparatus as defined in claim 24, wherein the prong guide further comprises a first and a second prong guide positioned to abuttingly contact and extend outwardly from a stop member positioned substantially adjacent the center of the fork lift apparatus so that the first prong guide is positioned to extend between a first one of the pair of side frame members and the stop member, and the second prong guide is positioned to extend between a second one of the pair of side frames members and the stop member, the first prong guide adapted to receive the prong guide connecting member of a first one of the pair of prong members and the second prong guide adapted to receive the prong guide connecting member of a second one of the pair of prong members, the first and second prong guides adapted to rotate independently of each other so that the first and second prong members slidably move along the fork guide independently of each other.

26. The fork lift apparatus comprising:
a base;
a fork lift frame slidably connected to outer peripheries of the base and positioned to move between an extended position and a retracted position along the outer peripheries of the base; and
a fork lift slidably connected to the fork lift frame and positioned to move between an elevated position and a lowered position along the fork lift frame so that the fork lift overlies the base when the fork lift frame is positioned in the retracted position.

27. A fork lift apparatus as defined in claim 26, further comprising an operator station slidably connected to a top portion of the fork lift to slidably extend between a retracted position and an extended position.

28. A fork lift apparatus as defined in claim 27, wherein the base further comprises a first pair of spaced-apart fork lift frame guide rails and wherein the fork lift frame is further positioned to slidably connect to the first pair of spaced-apart fork lift frame guide rails between the extended and retracted positions.

29. A fork lift apparatus as defined in claim 28, wherein the fork lift frame further comprises a pair of spaced-apart and opposing side frame members, each positioned to slidably connect to a respective one of the first pair of spaced-apart fork lift frame guide rails and including a second pair of spaced-apart fork lift frame guide rails positioned to extend upwardly along the pair of spaced-apart side frame members so that the fork lift slidably connects to the second pair of spaced-apart fork lift frame guide rails to slidably position the fork lift between the elevated position and the lowered position along the pair of spaced-apart and opposing side frame members.

30. A fork lift apparatus as defined in claim 29, wherein the fork lift further comprises a stationary fork guide and a rotatably prong guide positioned to overlie the base adjacent the fork lift frame, and a pair of spaced-apart prong members each having a fork guide connector and a prong guide connector, the fork guide connector positioned to slidably connect each of the pair of prong members to the fork guide, the prong guide connector positioned to matingly connect each of the pair of prong members to the prong guide so that the pair of prong members slidably extend between and open position and a closed position responsive to the rotation of the prong guide.

31. A fork lift apparatus as defined in claim 30, further comprising a plurality of omni-directional wheels connected to a bottom portion of the base so that the base moves in forward, rearward, lateral, and transverse directions.

32. A fork lift apparatus as defined in claim 31, further comprising a controller positioned to control the movement of the base, the movement of the fork lift frame between the extended and the retracted positions, the movement of the fork lift between the elevated and lowered positions, the movement of the prong members between the open and the closed positions, and the movement of the operator station between the extended and the retracted positions.

33. A fork lift apparatus as defined in claim 32, further comprising a drive assembly connected to the base, the fork lift frame, the fork lift, the plurality of omni-directional wheels, the prong members, the operator station, and the controller to drive the fork lift apparatus in the forward, rearward, lateral, and transverse directions, the fork lift frame between the extended and retracted positions, the fork lift between the elevated and lowered positions, the prong members between the open and closed positions, and the operator station between the extended and retracted positions, each moving independently of one another and responsive to the controller.

34. A fork lift apparatus as defined in claim 33, further comprising a weight balance meter positioned in communication with the controller to meter weight distributed on the fork lift apparatus as the fork lift frame is positioned between the retracted and extended position and as the fork lift is positioned between the elevated and lowered positions and as the base is positioned in the forward, rearward, lateral, and transverse directions so as to detect unbalanced weight distribution on the fork lift apparatus.

35. A fork lift apparatus as defined in claim 34, wherein the weight balance meter further comprises at least one strain gauge positioned to measure strain applied to the fork lift apparatus by a load positioned thereon and by the position of the base, the fork lift and the fork lift frame between the respective lowered and elevated positions and extended and retracted positions to thereby detect unbalanced weight distribution on the fork lift apparatus.

36. A fork lift apparatus as defined in claim 35, further comprising a weight distributor positioned in communication with the operator station and the controller to distribute weight throughout the fork lift apparatus, the weight distributor further comprising an operator station positioner to position the operator station between the retracted and extended positions responsive to the weight balance meter so that the weight of the operator station is used as a counter balance to the weight of the load.

37. A fork lift apparatus as defined in claim 36, wherein the fork lift frame and the base each further comprise a front and a rear and wherein the retracted position of the fork lift frame is further defined by the rear of the fork lift frame being positioned adjacent the rear of the base and the extended position of the fork lift frame is further defined by the rear fork lift frame being positioned spaced-apart from the rear of the base.

38. A fork lift apparatus as defined in claim 43, wherein the operator station further comprises a front and a rear, and wherein the extended position of the operator station is further defined by the rear of the operator station being positioned adjacent to the front of the base and the retracted position of the operator station is further defined by the rear of the operator station being positioned adjacent the rear of the base.

39. A fork lift apparatus as defined in claim 38, wherein each one of the pair of side frame members include a front and a rear and at least one wheel connected to a bottom portion thereof adapted to move in forward, rearward, lateral, and transverse directions during forward, rearward, lateral, and transverse movement of the base so that the movement of the base is not limited by the fork lift frame and so that the fork lift frame can be readily positioned between the extended and retracted positions during multi-directional movement of the fork lift apparatus.

40. A fork lift apparatus as defined in claim 39, wherein the fork guide further comprises substantially smooth outer peripheries and wherein the prong guide is a grooved prong guide positioned to underlie the fork guide so that the fork guide connector is positioned to slidably engage the fork guide, and the prong guide connector is positioned to matingly engage the prong guide to move the pair of prong members between the open and closed positions.

41. A fork lift apparatus as defined in claim 40, wherein the prong guide connector further comprises a prong guide connecting member extending from an inner periphery of the prong guide connecting member to engage a plurality of grooves positioned on outer peripheries of the grooved prong guide so that each of the pair of prong members extend between the opened and closed positions responsive to the rotation of the grooved prong guide.

42. A fork lift apparatus as defined in claim 41, wherein the prong guide further comprises a first and a second prong guide positioned to abuttingly contact and extend outwardly from a stop member positioned substantially adjacent the center of the fork lift apparatus so that the first prong guide is positioned to extend between a first one of the pair of side frame members and the stop member, and the second prong guide is positioned to extend between a second one of the pair of side frames members and the stop member, the first prong guide adapted to receive the prong guide connecting member of a first one of the pair of prong members and the second prong guide adapted to receive the prong guide connecting member of a second one of the pair of prong members, the first and second prong guides adapted to rotate independently of each other so that the first and second prong members slidably move along the fork guide independently of each other.

43. A fork lift apparatus comprising:
a base;
a fork lift connected to the base and positioned to slidably move between an elevated and a lowered position; and
an operator station slidably connected to a top portion of the fork lift to slidably extend between a retracted position and an extended position so that the operator is positioned in the retracted position to counterbalance a load positioned on the fork lift.

44. A fork lift apparatus as defined in claim 43, further comprising a fork lift frame slidably connected to outer peripheries of the base and positioned to move between an extended position and a retracted position along the outer peripheries of the base, and wherein the fork lift if further slidably connected to the fork lift frame so that the fork lift overlies the base when the fork lift frame is positioned in the retracted position.

45. A fork lift apparatus as defined in claim 44, wherein the base further comprises a first pair of spaced-apart fork lift frame guide rails and wherein the fork lift frame is further positioned to slidably connect to the first pair of spaced-apart fork lift frame guide rails between the extended and retracted positions.

46. A fork lift apparatus as defined in claim 45, wherein the fork lift frame further comprises a pair of spaced-apart and opposing side frame members, each positioned to slidably connect to a respective one of the first pair of spaced-apart fork lift frame guide rails and including a second pair of spaced-apart fork lift frame guide rails positioned to extend upwardly along the pair of spaced-apart side frame members so that the fork lift slidably connects to the second pair of spaced-apart fork lift frame guide rails to slidably position the fork lift between the elevated position and the lowered position along the pair of spaced-apart and opposing side frame members.

47. A fork lift apparatus as defined in claim 46, wherein the fork lift further comprises a stationary fork guide and a rotatably prong guide positioned to overlie the base adjacent the fork lift frame, and a pair of spaced-apart prong members each having a fork guide connector and a prong guide connector, the fork guide connector positioned to slidably connect each of the pair of prong members to the fork guide, the prong guide connector positioned to matingly connect each of the pair of prong members to the prong guide so that the pair of prong members slidably extend between and open position and a closed position responsive to the rotation of the prong guide.

48. A fork lift apparatus as defined in claim 47, further comprising a plurality of omni-directional wheels connected to a bottom portion of the base so that the base moves in forward, rearward, lateral, and transverse directions.

49. A fork lift apparatus as defined in claim 48, further comprising a controller positioned to control the movement of the base, the movement of the fork lift frame between the extended and the retracted positions, the movement of the fork lift between the elevated and lowered positions, the movement of the prong members between the open and the closed positions, and the movement of the operator station between the extended and the retracted positions.

50. A fork lift apparatus as defined in claim 49, further comprising a drive assembly connected to the base, the fork lift frame, the fork lift, the plurality of omni-directional wheels, the prong members, the operator station, and the controller to drive the fork lift apparatus in the forward, rearward, lateral, and transverse directions, the fork lift frame between the extended and retracted positions, the fork lift between the elevated and lowered positions, the prong members between the open and closed positions, and the operator station between the extended and retracted positions, each moving independently of one another and responsive to the controller.

51. A fork lift apparatus as defined in claim 50, further comprising a weight balance meter positioned in communication with the controller to meter weight distributed on the fork lift apparatus as the fork lift frame is positioned between the retracted and extended position and as the fork lift is positioned between the elevated and lowered positions and as the base is positioned in the forward, rearward, lateral, and transverse directions so as to detect unbalanced weight distribution on the fork lift apparatus.

52. A fork lift apparatus as defined in claim 51, wherein the weight balance meter further comprises at least one strain gauge positioned to measure strain applied to the fork lift apparatus by the load and by the position of the base, the fork lift and the fork lift frame between the respective lowered and elevated positions and extended and retracted positions to thereby detect unbalanced weight distribution on the fork lift apparatus.

53. A fork lift apparatus as defined in claim 52, further comprising a weight distributor positioned in communication with the operator station and the controller to distribute weight throughout the fork lift apparatus, the weight distributor further comprising an operator station positioner to position the operator station between the retracted and extended positions responsive to the weight balance meter so that the weight of the operator station is used as a counter balance to the weight of the load.

54. A fork lift apparatus as defined in claim 53, wherein the fork lift frame and the base each further comprise a front and a rear and wherein the retracted position of the fork lift frame is further defined by the rear of the fork lift frame being positioned adjacent the rear of the base and the extended position of the fork lift frame is further defined by the rear fork lift frame being positioned spaced-apart from the rear of the base.

55. A fork lift apparatus as defined in claim 54, wherein the operator station further comprises a front and a rear, and wherein the extended position of the operator station is further defined by the rear of the operator station being positioned adjacent to the front of the base and the retracted position of the operator station is further defined by the rear of the operator station being positioned adjacent the rear of the base.

56. A fork lift apparatus as defined in claim 55, wherein each one of the pair of side frame members include a front and a rear and at least one wheel connected to a bottom portion thereof adapted to move in forward, rearward, lateral, and transverse directions during forward, rearward, lateral, and transverse movement of the base so that the movement of the base is not limited by the fork lift frame and so that the fork lift frame can be readily positioned between the extended and retracted positions during multi-directional movement of the fork lift apparatus.

57. A fork lift apparatus as defined in claim 56, wherein the fork guide further comprises substantially smooth outer peripheries and wherein the prong guide is a grooved prong guide positioned to underlie the fork guide so that the fork guide connector is positioned to slidably engage the fork guide, and the prong guide connector is positioned to matingly engage the prong guide to move the pair of prong members between the open and closed positions.

58. A fork lift apparatus as defined in claim 57, wherein the prong guide connector further comprises a prong guide connecting member extending from an inner periphery of the prong guide connecting member to engage a plurality of grooves positioned on outer peripheries of the grooved prong guide so that each of the pair of prong members extend between the opened and closed positions responsive to the rotation of the grooved prong guide.

59. A fork lift apparatus as defined in claim 58, wherein the prong guide further comprises a first and a second prong guide positioned to abuttingly contact and extend outwardly from a stop member positioned substantially adjacent the center of the fork lift apparatus so that the first prong guide is positioned to extend between a first one of the pair of side frame members and the stop member, and the second prong guide is positioned to extend between a second one of the pair of side frames members and the stop member, the first prong guide adapted to receive the prong guide connecting member of a first one of the pair of prong members and the second prong guide adapted to receive the prong guide connecting member of a second one of the pair of prong members, the first and second prong guides adapted to rotate independently of each other so that the first and second prong members slidably move along the fork guide independently of each other.

60. A method of positioning a load within a predetermined area using a fork lift apparatus having a base with a longitudinal axis, the method comprising:
longitudinally moving the fork lift apparatus in a first predetermined direction along a longitudinal axis of the predetermined area so that the longitudinal axis of the base is positioned substantially parallel to the longitudinal axis of the predetermined area;
extending a fork lift frame so that a fork lift connected thereto is positioned to engage and lift the load; and
laterally moving the fork lift apparatus in a second predetermined direction so that the longitudinal axis of the base is positioned substantially perpendicular to the longitudinal axis of the predetermined area.

61. A method as defined in claim 60, further comprising diagonally moving the fork lift apparatus in a third predetermined direction so that the longitudinal axis of the base is positioned transverse to the longitudinal axis of the area.

62. A method as defined in claim 61, further comprising elevating and lowering the fork lift having the load positioned thereon when the fork lift apparatus is moved in the first, second, or third predetermined directions.

63. A method as defined in claim 62, further comprising extending and retracting the fork lift frame when the fork lift apparatus is moved in the first, second, or third predetermined directions.

64. A method as defined in claim 63, further comprising retracting the fork lift frame and lowering the fork lift having the load positioned thereon so that the load is positioned to rest on the base when the fork lift apparatus is stationary or moved in the first, second, or third predetermined directions.

65. The method as defined in claim 64, further comprising counter-balancing the load positioned on the fork lift by laterally extending and retracting an operator station along the fork lift frame.

66. A method as defined in claim 65, further comprising extending and retracting the operator station when the fork lift apparatus is moved in the first, second, or third predetermined directions.

67. A method of positioning a load within a predetermined narrow area using a fork lift apparatus having a base with a longitudinal axis, the method comprising:
diagonally moving the fork lift apparatus in a predetermined direction so that the longitudinal axis of the base is positioned transverse to a longitudinal axis of the narrow area; and
extending a fork lift frame so that a fork lift connected thereto is positioned to engage and lift the load.

68. A method as defined in claim 67, further comprising longitudinally moving the fork lift apparatus so that the longitudinal axis of the base is positioned substantially parallel to the longitudinal axis of the narrow area.

69. A method as defined in claim 68, further comprising laterally moving the fork lift apparatus so that the longitudinal axis of the base is positioned substantially perpendicular to the longitudinal axis of the narrow area.

70. A method as defined in claim 69, further comprising elevating and lowering the fork lift having the load positioned thereon when the fork lift apparatus is moved in the diagonal, lateral, or longitudinal directions.

71. A method as defined in claim 70, further comprising extending and retracting the fork lift frame when the fork lift apparatus is moved in the diagonal, lateral, or longitudinal directions.

72. A method as defined in claim 71, further comprising retracting the fork lift frame and lowering the fork lift having the load positioned thereon so that the load is positioned to rest on the base when the fork lift apparatus is stationary or moved in the diagonal, lateral, or longitudinal directions.

73. A method as defined in claim 72, further comprising counter-balancing the load positioned on the fork lift by laterally extending and retracting an operator station along the fork lift frame.

74. A method as defined in claim 73, further comprising extending and retracting the operator station when the fork lift apparatus is moved in the diagonal, lateral, or longitudinal directions.

75. A method of balancing a fork lift apparatus having a base, the method comprising:
extending a fork lift frame having a fork lift connected thereto to engage and lift a load; and
counter-balancing the load positioned on the fork lift by laterally extending and retracting an operator station along the fork lift frame.

76. A method as defined in claim 75, further comprising extending and retracting each one of a pair of prong members positioned to extend outwardly from the fork lift between an open and a closed position so that the prong members of the fork lift are positioned to engage and lift the load in a balanced manner.

77. A method as defined in claim 76, further comprising longitudinally moving the fork lift apparatus in a first predetermined direction along a longitudinal axis of a predetermined area so that a longitudinal axis of the base is positioned parallel to the longitudinal axis of the predetermined area.

78. A method as defined in claim 77, further comprising laterally moving the fork lift apparatus in a second predetermined direction so that the longitudinal axis of the base is positioned substantially perpendicular to the longitudinal axis of the predetermined area.

79. A method as defined in claim 78, further comprising diagonally moving the fork lift apparatus in a third predetermined direction so that the longitudinal axis of the base is positioned transverse to the longitudinal axis of the predetermined area.

80. A method as defined in claim 79, further comprising elevating and lowering the fork lift having the load positioned thereon when the fork lift apparatus is moved in the first, second, or third predetermined directions.

81. A method as defined in claim 80, further comprising extending and retracting the fork lift frame when the fork lift apparatus is moved in the first, second, or third predetermined directions.

82. A method as defined in claim 81, further comprising retracting the fork lift frame and lowering the fork lift having the load positioned thereon so that the load is positioned to rest on the base when the fork lift apparatus is stationary or moved in the first, second, or third predetermined directions.

83. A method as defined in claim 82, further comprising counter-balancing the load positioned on the fork lift by laterally extending and retracting an operator station along the fork lift frame.

84. A method as defined in claim 83, further comprising extending and retracting the operator station when the fork lift apparatus is moved in the first, second, or third predetermined directions.

85. A method of moving a load using a fork lift apparatus having a base, the method comprising:
extending a fork lift frame from a retracted position to engage a load;
elevating a fork lift connected to the fork lift frame to lift the load; and
retracting the fork lift frame to a retracted position so that the lifted load of the elevated fork lift is positioned to overlie the base.

86. A method as defined in claim 85, further comprising longitudinally moving the fork lift apparatus in a first predetermined direction along a longitudinal axis of a predetermined area so that a longitudinal axis of the base is positioned parallel to the longitudinal axis of the predetermined area.

87. A method as defined in claim 86, further comprising laterally moving the fork lift apparatus in a second predetermined direction so that the longitudinal axis of the base is positioned substantially perpendicular to the longitudinal axis of the predetermined area.

88. A method as defined in claim 87, further comprising diagonally moving the fork lift apparatus in a third predetermined direction so that the longitudinal axis of the base is positioned transverse to the longitudinal axis of the predetermined area.

89. A method as defined in claim 88, further comprising counter-balancing the load by laterally extending and retracting an operator station along the fork lift frame when the fork lift apparatus is moved in the first, second, or third predetermined directions.
